(19) United States
(12) Patent Application Publication
(10) Pub. No.: US 2002/0117811 A1
(43) Pub. Date: Aug. 29, 2002

(54) Cavity sealant

(76) Inventors: Kirk Kobmann, Canton, MI (US); David Franey, Wyandotte, MI (US); Mark Whaley, Southfield, MI (US); David Horton, Tecumseh (CA)

Correspondence Address: ORSCHELN MANAGEMENT CO, 2000 US HWY 63 SOUTH, MOBERLY, MO, 65270, US

(21) Appl. No.: 09/991,016

(22) Filed: Nov. 16, 2001

Related U.S. Application Data
(60) Provisional application No. 60/252,494, filed on Nov. 22, 2000.

(51) Int. Cl. F02F 11/00

(52) U.S. Cl. 277/591

(57) ABSTRACT

A cavity sealer or tub is disclosed that provides a self-sealing and self-retaining member for sealing at least two and typically at least three metallic members (e.g., automotive architectural, structural, among other components or members). The sealer bonds to and becomes integral with the sealed metallic members.

The subject matter disclosed herein claims benefit of U.S. patent application Ser. No. 60/252,494, filed Nov. 22, 2000; the disclosure of which is hereby incorporated by reference.

### FIELD OF THE INVENTION

The instant invention relates to sealing an opening defined between at least two metallic components. One aspect of the invention relates to sealing an opening defined between at least two automotive components.

### BACKGROUND OF THE INVENTION

It is known in the art to employ mastics, foams and expandable materials for sealing cavities as well as to seal joints between metal components. In the case of automotive components, metal is typically stamped into a desired configuration and the joint between the stamped metal components is sealed (e.g., to control wind, dust, noise and water intrusion). Metals have limitations on the shape that can be achieved by stamping which in turn complicates effective sealing of metal joints. These limitations are especially acute when using a metallic article for sealing an automotive floor pan to other body architecture. Conventional practice for sealing an automotive floor pan to body architecture requires multiple sealants which in turn requires multiple application steps. There is a need in this art for a cavity sealer that more effectively seals the cavity and reduces the costs associated with multiple sealant application.

### SUMMARY OF THE INVENTION

The inventive cavity sealer or tub solves problems associated with conventional cavity sealants including reducing sealant installation time, and eliminating the need to drill holes (also known in the art as “rat-holes”), while increasing the ease and effectiveness of sealing (e.g., obviating pumpable sealants). The inventive cavity sealer also reduces the number of components required to seal a predetermined area thereby providing manufacturing flexibility or build advantages and reducing vehicle weight, among other advantages over conventional metallic components and sealants.

The inventive cavity sealer or tub also solves problems associated with conventional sealant systems by providing a self-sealing and self-retaining member for sealing at least two and typically at least three metallic members (e.g., automotive architectural, structural, among other components or members). The inventive cavity sealer bonds to and becomes integral with the sealed metallic members. If desired, the inventive cavity sealer can obviate welding as a method for installing the sealer.

The inventive cavity sealer relates to a molded self-sealing component that is integral to the vehicular structure and/or architecture. One example of the inventive cavity sealer comprises an automotive floor pan extension. In this aspect of the invention, the cavity sealer extends from the floor pan outwardly towards at least one of body sheet metal, reinforcing members, support members, among other vehicle members. While the inventive cavity sealer can be employed in any suitable location, the cavity sealer is typically employed in left and right handed applications thereby extending or joining the floor pan as needed to other members of the vehicle.

In a first aspect of the invention, the cavity sealer comprises a moldable material such as a glass-filled polypropylene body, having at least one weldable metallic insert. The inserts are employed for welding the tub assembly to surrounding metal components or members, e.g., body sheet metal. While the cavity sealer can be welded as appropriate for a particular location, the cavity sealer is typically welded to vehicle members in at least two locations.

In another aspect of the invention, the cavity sealer comprises a molded tub that is self-retaining or maintained in a predetermined position by compression or snap-fit. The self-retaining feature can be achieved in any suitable manner such as flexible tabs, compressible members such as clips, rivets, clasp, latch, peg, among other features extending from the cavity sealer and engaging channels, grooves, protuberances, or openings defined within the metallic members to be sealed. Alternatively, the self-retaining feature can be achieved by features extending from the metallic members to be sealed and engaging channels, grooves, protuberances or openings defined in the cavity sealer.

The cavity sealer can further comprise at least one heat expandable sealant material. The expandable material can be employed at any suitable locations upon the cavity sealer, e.g., along at least a portion of the assembly perimeter, adjacent to welded regions, along a longitudinal axis of the cavity sealer, adjacent to compression fittings, among other suitable locations. While any suitable heat expandable sealer can be used, examples of suitable sealers are disclosed in U.S. Pat. Nos. 4,427,481; 4,874,650; 5,040,803; 5,266,133; 5,373,027; 5,506,025; 5,266,133; 5,373,027; and 5,678,826; and European Patent No. EP 0 730 998B1; as well as copending and commonly assigned U.S. patent application Ser. No. 09/696,854, filed on Oct. 26, 2000 and entitled “Exapandable Compositions and Methods For Making and Using the Compositions” (corresponding to PCT Publication No. WO 01/30906 A1); the disclosure of each of the foregoing patents, patent applications and publications is hereby incorporated by reference. Depending upon composition and length of heat exposure, the heat expandable material can increase its volume from about 300 to 1,000 percent. The heat for expanding the expandable material can be supplied from any suitable source such as heat from baking ovens used to treat painted automotive components, infrared heating, induction heating, among other conventional heating methods. The heat expandable material can be combined with the tub component of the cavity sealer by any suitable method such as adhesive contact, fastened onto the assembly, molded onto or over molded onto the tub, among other suitable combination methods.

### BRIEF DESCRIPTION OF THE DRAWINGS

FIGS. 1A and 1B illustrate an isometric and a cross-sectional view of one aspect of the inventive tub having weldable inserts.

FIGS. 2A through 2D illustrate isometric views of another aspect of the invention tub having self-retaining or compression fittings.

### DETAILED DESCRIPTION

The inventive cavity sealer comprises a moldable material such as a glass-filled polypropylene, and if desired having at least one weldable metallic insert. The inventive cavity sealer can be employed for sealing an opening defined between at least two and typically three adjacent automotive structural, architectural, body among other components or members. By “adjacent” as used in this specification and the claims, unless expressly stated otherwise, means two members that are in contact with each other, are next to each other with a space separating them, or are next to each other with a third component in between. Examples automotive members that can be sealed by the inventive cavity sealer comprises at least one member selected from the group comprising frame rails, rear floor pan flange, D-pillar inner, body sides, rear sills, wheel housing, among others.

The tub can also be fabricated from moldable polyester, polypropylene polyethylene terephthalate (PET) which is supplied commercially by DuPont as Rynite®, materials satisfying Ford Performance Specification ESBM18P11-A (hereby incorporated by reference), among other suitable materials. By “moldable” as used in this specification and the claims, unless expressly stated otherwise, means that the material can be fabricated or shaped by using conventional methods such as injection molding, vacuum forming, blow molding, stamping, die-cutting, among other conventional methods for shaping thermoplastic or thermoset materials. The ability to mold (e.g., injection mold) the tub permits fabricating a tub having a virtually unlimited array of irregular, non-symmetrical and other non-uniform configurations. The specific dimensions of the tub and cavity sealer can similarly vary widely and are limited only by molding methods. The moldable material can be reinforced by fibers (e.g., glass or mineral fibers), rods, strips, particulate, among other conventional reinforcing materials. Depending upon the location of the cavity, the cavity sealer can be fabricated from a pigmented material or a material that is paint receptive. While the amount of reinforcement depends upon the composition of the surrounding material and location of the cavity sealer, the reinforcement comprises about 30 to about ______ wt. % of the composition. The moldable material should also possess sufficient chemical resistance, impact resistance, temperature resistance (e.g., a melt point greater than the heat used for expanding the expandable material), among other properties suitable for its end use.

In one aspect of the invention, the inventive cavity sealer can include at least one weldable insert embedded within or extending along the tube that are employed for welding the cavity sealer to surrounding metallic members. Weldable metal inserts can be fabricated from any suitable material such as cold-rolled steel, e.g., satisfying automotive specification WSD-M1A333-A2 60G60G hereby incorporated by reference, zinc plated steel, stainless steel, among other weldable materials. The weldable insert can be shaped as appropriate by using any conventional shaping methods such as stamping, cutting, drawing, among other methods.

In another aspect of the invention, a heat expandable material is in contact with at least a portion of the tub of the cavity sealer. The heat expandable material can be located at or along any suitable location(s) of the tub. The heat expandable material functions to bond the cavity sealer to adjacent metallic members, and seal the members (and in turn the interior of the automobile) from air, noise, dust and water intrusion. While any suitable heat expandable material can be employed, a specific example of a suitable material comprises commercially available Orbseal® 212002 (Orbseal LLC, Plymouth, Mich.) that expands at least about 300% to at least about 1,000% when exposed to a sufficient amount of heat. When sealing an automotive member such as a rear portion of the floor pan to the body side and rear sill or wheel housing, heat is normally supplied by exposure to paint ovens that are used during automotive assembly. The expandable material can be attached to the tub assembly in any suitable manner such as heat staking, fasteners, insert molding, among other methods for attaching the expandable material to the tub. If desired, the tub can be injection molded and then a pelletized heat expandable material will be overmolded upon selected areas of the previously molded tub.

In a further aspect of the invention, the tub and heat expandable material are separately injection molded. The specific configuration of the tub and heat expandable material is defined by the metallic members to be sealed. A tub can be fabricated from an injection moldable material (e.g., Ryanite® SST-35 PET) in powdered or pelletized form. Prior to injection molding, the material is dried to remove moisture. The dried pellets are heated to a temperature of about 500 to 575 F. and injected into a mold at a pressure of about 1,500 to 2,500 psi in a 500 ton horizontal injection molding apparatus. The injection molded material is permitted to cool for about 30-60 seconds and is then removed from the mold. The heat expandable material can also be injection molded by using powdered or pelletized material. While any suitable injection moldable and heat expandable material can be employed, an ethyl vinyl acetate rubber based material can achieve desirable results. The pelletized heat expandable material is heated to a temperature of about 150 to 175 F., and injection molded in a 200 ton horizontal injection molding apparatus. The injection molded heat expandable material can then be affixed to the tub at a desired location by any suitable method, e.g., fasteners, interference fit within channels or openings defined in the tub, among other methods.

The cavity sealer can be assembled or located within or adjacent to the members to be sealed in any suitable method. The cavity sealer can be attached to the vehicle by welding the cavity sealer to the vehicle at the molded metal inserts. Alternatively, the cavity sealer can be self-retaining (without metal inserts) and maintained at a predetermined location by employing self-retaining features (e.g., compression fasteners or snap fit). If desired, the weldable and self-retaining features can be combined. A heat expandable sealant (e.g., injection-molded sealer) will be located so as to expand and seal (e.g., the perimeter) the floor pan extension/tub to the surrounding areas.

In one aspect of the invention, the cavity sealer (e.g,. comprising a floor pan extension) is installed within an automobile sub-assembly for sealing adjacent metallic members. The cavity sealer utilizes locking tabs, compression fittings, interference fittings, among other means for retaining the cavity sealer in a predetermined region. The cavity sealer can be installed prior to applying e-coat or other paint systems. After installation, the automotive sub-assembly as well as the cavity sealer are processed through a paint system. As a result, the cavity sealer is exposed to at least one source of heat, e.g., a first heat bake of about 350 F. for 30 minutes followed by a second heat bake of 320 F. for 20 minutes. The heat source causes the heat expandable material of the cavity sealer to expand thereby sealing the tub to adjacent metallic members.

If desired any fasteners associated with installing the cavity sealer can be molded into the tub. Examples of suitable fasteners comprise at least one member selected from the group consisting of pins, clips, prongs, screws, nuts, among other fastening means. Further, the cavity sealer can define openings or fixtures for material storage, article mounting (e.g., electronic packaging, heat-cooling-ventilation components, among other non-structural or architectural members), receiving fasteners, wiring, conduits (e.g., exhaust), among other operations.

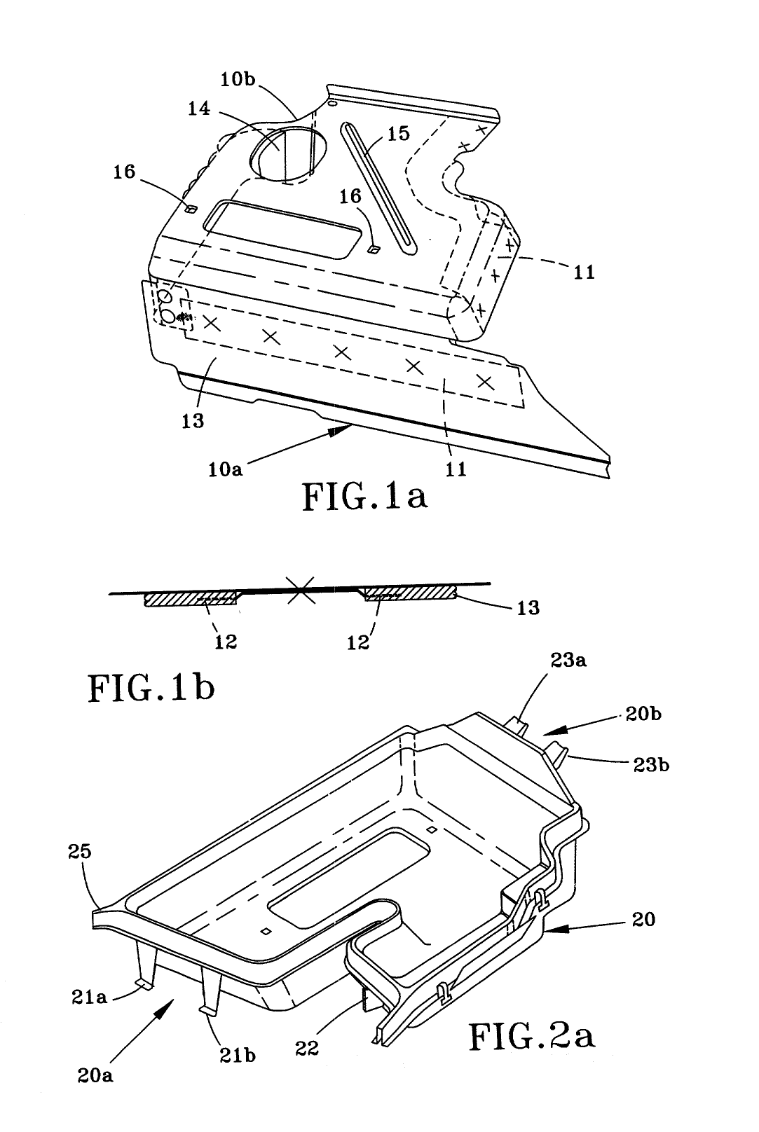

Certain aspects of the invention are better understood by reference to the Drawings. Referring now to FIGS. 1A and 1B, while the tub of the cavity sealer can be fabricated to a virtually unlimited array of configurations these drawings illustrate a left hand cavity sealant or floor pan extension 10 that is associated with an automotive auxiliary air conditioning unit (not shown). In this aspect of the invention, the right hand extension can be associated with a sound system component such as a speaker (not shown). Portion 10A of floor pan extension or cavity sealer is adjacent to or bonded to the rear body member of an automobile. Portion 10B of floor pan extension or cavity sealer is adjacent to or bonded to a wheel housing of the automobile. The metal inserts 11 are at least partially encapsulated by a moldable material, e.g., polypropylene. The metal inserts 11 can be welded to adjacent metallic members to be sealed by the cavity insert. Typical welding locations are illustrated by “x”. The metal inserts 11 can define openings or regions 12 that enhance the bonding between the moldable material 13 and the metal inserts 11. The depth into which the metal inserts 11 are inserted into the moldable material 13 can vary widely depending upon the materials and end use, a typical depth is about 15 mm. While a moldable material having any suitable thickness can be employed, a typical thickness is about 0.8 mm. In one aspect the bonding region 12 comprises openings through which the moldable material 13 can flow. The size of the openings, thickness of the moldable material, degree of encapsulation, among other dimensional characteristics shown on the drawings are provided to illustrate certain aspects of the invention and not to limit the scope of any claims appended hereto. A heat expandable sealant (not shown) is employed for sealing the welded floor pan extension from water, wind, dust and noise intrusion.

The illustrated cavity sealer defines an opening 14 for an exhaust of the auxiliary air-conditioning unit. The tub also defines a raised reinforcement rib 15. Such ribs are included as appropriate depending upon the size of the tub, materials of construction, weight of objects to be located within the tub, among other parameters. The cavity sealer can also include a plurality of openings 16 for receiving fasteners.

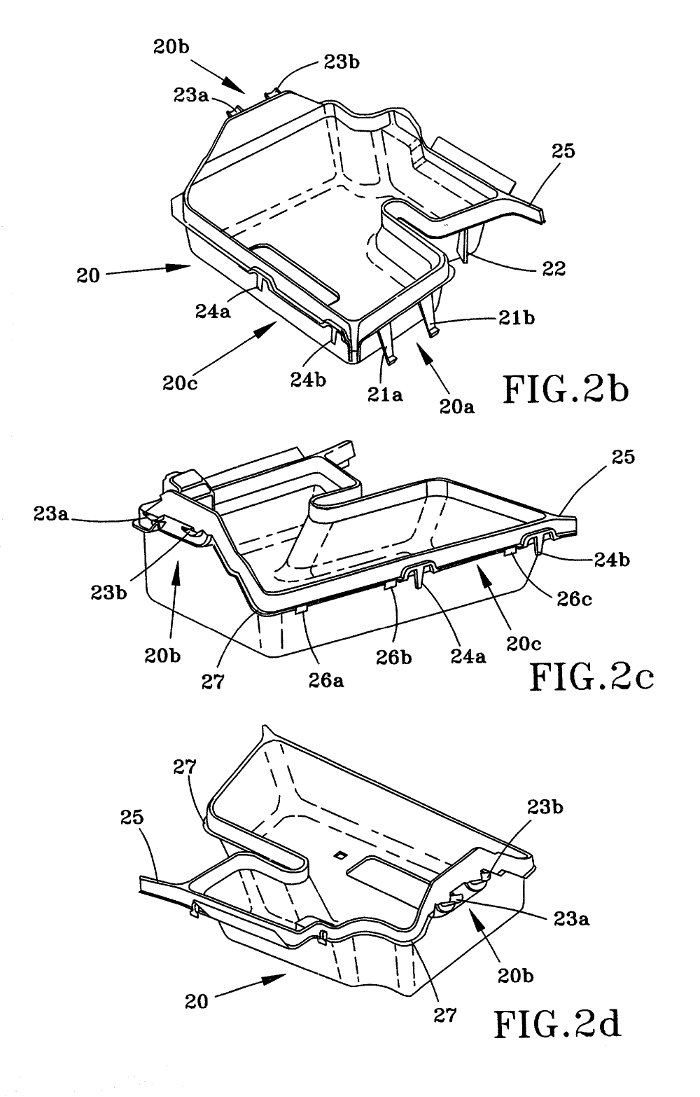

Referring now to FIGS. 2A through 2D, FIGS. 2A through 2D illustrate another aspect of the invention wherein the tub comprises self-retaining features. While the cavity sealer can have a wide range of configurations, the cavity sealer illustrated in these FIGS. 2A through 2D measures generally 15 inches long, 11 inches wide and 4 inches in depth. The rectangular openings shown in FIGS. 2A through 2D accommodates a bracket, heat and cooling components, permits paint systems to drain among other functions. Referring now to FIGS. 2A through 2D, these Figures show another version of a floor pan extension or cavity sealer (also known as a “D” tub) illustrated in FIGS. 1A and 1B. FIGS. 2A through 2D illustrate a cavity sealer or floor pan extension 20. The configuration and profile of floor pan extension 20 provides a seal among the D-pillar, inboard weld plate, rear sill, wheelhouse inner, wheelhouse outer and body side. Portion 20A (not shown in FIGS. 2C and 2D) of cavity sealer 20 includes locking tabs 21A/B. Locking tabs 21A/B engage openings defined in one of the metal members (not shown) to be sealed. Fin or protuberance 22 functions to assist in locating tub 20 among the members to be sealed. Locking tabs 21A/B and protuberance 22 secure floor pan extension 20 into a fixed location.

Portion 20B of floor pan extension 20 defines open channels 23A/B that are received in openings defined in one of the members (not shown) to be sealed. Portion 20C of floor pan extension 20 include downwardly extending and recessed locking tabs 24A/B. Locking tabs 24A/B engage openings defined in one of the members (not shown) to be sealed. The floor pan extension 20 is installed by inserting open channels 23A/B into one member to be sealed and then applying a downward force that causes locking tabs 21A/B and 24A/B to engage openings (e.g., snap-fit) in their respective members to be sealed.

A heat expandable material 25 extends around the upper perimeter of floor pan extension 20. The heat expandable material 25 has a volume and thickness that is sufficient to provide a seal that inhibits, if not eliminates, water, dust and wind intrusion into the automobile. The heat expandable material 25 includes tabs 26A/B/C (best shown in FIG. 2C) that extend through openings defined in tub 20. The tabs 26A/B/C are interference fit within such openings and maintain heat expandable material 25 at a predetermined location about tub 20 (tabs 26A/B/C are employed when the heat expandable material is fabricated separately from the tub). The heat expandable material 25 can be housed upon a ledge, groove or channel 27 defined about a periphery of tub 20. The floor pan extension 20 is inserted among the members to be sealed, the locking features (e.g., tabs 21A/B and 24A/B) engage and maintain the extension 20 at a predetermined location and expandable material 25 is heated in a manner sufficient to activate the material thereby bonding and sealing portion 20 to the adjacent metallic members.

The inventive cavity sealer can be employed along with conventional sealants, adhesives, foams, mastics, among other materials employed for sealing an automobile. While the above disclosure places particular emphasis on an automotive cavity sealer (e.g., a floor pan extension), for sealing at least two and typically at least three metallic members, the inventive cavity sealer can be employed in any application wherein it is desirable to employ a molded material (e.g., for components having a configuration too complex for metal), and sealed to a metallic member, molded material seal or join at least two previously formed vehicular structure and/or architectural components, among other applications.

The following is claimed:

1). A sealant comprising a non-symmetrical tub having at least one fastening feature wherein at least one heat expandable material contacts at least a portion of the tub.

2). An automotive floor pan extension comprising an injection molded component having at least one integrally molded locking feature and wherein at least one sealant contacts at least a portion of the injection molded component.

3) A sealed region comprising at least three metallic automotive members at least partially in contact with a cavity sealer, wherein said cavity sealer comprises a molded component having at least locking feature, and wherein at least one heat activated sealant contacts at least a portion of said cavity sealer and said at least three metallic automotive members.

4). The sealant of claim 1 wherein said fastening feature comprises at least one weldable metal.

5). The sealant of claim 1 wherein said fastening feature comprises at least one self-locking tab.

6). The automotive floor pan extension of claim 2 wherein said sealant comprises a heat activated and expandable sealant.

7). The sealed region of claim 3 wherein one of said at least three automotive components comprises a floor pan.

8). The sealant of claim 1 wherein said tub comprises polyethylene terephthalate.

9). The automotive floor pan extension of claim 2 wherein the injection molded component comprises a fiber reinforced thermoset composite.

10). The sealed region of claim 3 wherein said molded component comprises injection moldable polyproplyene.

11). The sealed region of claim 3 wherein said at least one locking feature engages opening defined in at least one of said at least three metallic automotive members.
